(19) United States
(12) Patent Application Publication
(10) Pub. No.: US 2004/0230593 A1
(43) Pub. Date: Nov. 18, 2004

(54) Anonymous advertisement intermediation

(76) Inventors: Harry R. Rudin, Oberrieden (CH); Markus G. Stolze, Adliswil (CH); Elsie A. Van Herreweghen, Horgen (CH)

Correspondence Address: Ido Tuchman, Suite 503, 69-60 108th Street, Forest Hills, NY, 11375, US

(21) Appl. No.: 10/837,808

(22) Filed: May 3, 2004

(30) Foreign Application Priority Data
May 16, 2003 (EP) 03405339.7

(51) Int. Cl. G06F 17/00

(52) U.S. Cl. 707/100

(57) ABSTRACT

A method, system and computer program product for delivering electronic information anonymously from a first party to a user, in particular to the delivery of advertisement via the Internet. The method for delivering electronic information anonymously from the first party via a second party to a third party as user includes the operations of providing the information received from the first party, receiving a preference request from the user via the second party comprising a session key and a request that applies the session key, and responsive to the request and in the event that the request matches with the provided information, providing to the third party a response comprising a matching information that applies the session key.

### CROSS-REFERENCE TO RELATED APPLICATIONS

This application claims priority to European Patent Application No. 03405339.7 filed May 16, 2003, the entire text of which is specifically incorporated by reference herein.

### FIELD OF THE INVENTION

The present invention relates to a method and system for delivering electronic information anonymously from a first party to a user, in particular to the delivery of advertisement via the Internet.

### BACKGROUND

Unsolicited commercial e-mail, referred to herein as UCE, is already a major problem on the Internet and is steadily growing worse. It is estimated that 45 percent of the overall e-mail traffic is unwanted bulk e-mail (The Economist, Apr. 26th 2003, page 54). With approximately one billion e-mail users, the Internet is an irresistibly attractive means of delivering advertising. In general, there seem to be four main channels for providing and delivering advertisements over the Internet:

1) UCE or “spam”, where unsolicited commercial e-mail is sent to vast numbers of mostly unwilling recipients. Despite the strong negative connotation, this is an attractive option to advertisers since nearly all the cost is shifted to the customer and his or her Internet Service Provider.

2) Sponsored links such as those found in search engines such as Google.com. For example, in response to a search, Google offers a related sponsored link to the advertiser.

3) Banners used on many portals and Web-sites. Banners have not been very successful economically so far.

4) “Admediation”, wherein one voluntarily becomes a member of a group and as a result receives advertising e-mail for a broad product category. These schemes use gimmicks such as contests, earning points and lotteries to attract customers.

Both advertisers, i.e. sellers, and admediators are potential sources of spam or leaks of a user's personal information (e-mail address and other information) and preferences. In general, no service exists allowing users to register for receiving exactly the advertisements he or she wants and for as long as he or she wants, without danger of being spammed based on non-existing or old preferences.

### SUMMARY OF THE INVENTION

The present invention address the above-referenced limitations of conventional Internet advertising by introducing a new service for the delivery of electronic information, referred to as an “anonymediary” service. The anonymediary service fulfills the function of an admediary in that it delivers advertisements from different advertisers or sellers to potential customers in a way which allows customers to receive only the advertisements they are interested in, i.e. by matching a customer's profile or preferences against that of advertisements, and for a customer-specified period of time, while remaining anonymous to the sellers. Such a scheme or service can allow users to register to it, state preferences as to which advertisements the user is interested in, decide (and be able to enforce) how long this registration should last (1 day, 1 month, 1 year, etc.), and ideally would not give any personal information, including e-mail or other location or reachability information, to advertisers or admediaries. Such a service, if successful, may substantially decrease the amount of spam transmitted on the Internet. The anonymediary's service could be advertised via a pop-up window on a Web portal, for example.

Thus, one embodiment of an anonymediary service contemplated by the present invention puts the user in control and guarantees the user's anonymity. The user specifies not only what material he or she is interested in receiving, but also for how long. The anonymediary service can be realized by adding only one anonymediary entity, or by two separate entities: an anonymizing entity (or infrastructure) and an admediary entity. The term anonymediary is used regardless of how the invention is implemented: the admediary offering the anonymized service, whether in the one-entity setting by playing both roles, or in the two-entity setting by allowing anonymous access.

The anonymediary service is most likely financed by advertisers, but a model where users register for a fee is also conceivable. In the more likely scheme, the anonymediary receives either a fixed payment or a per-enquiry payment from the advertisers. The advertiser might want proof that payments to the anonymediary are effective. Since the potential customer remains unknown to the advertiser as well as to the anonymediary, the potential customer or user could be given a unique certificate entitling the customer to a discount on an actual purchase. Receipts of these certificates in the course of a sale would indicate the degree of success of the anonymediary.

In accordance with the present invention, there is provided a method for delivering electronic information anonymously from a first party via a second party to a third party as user. The method is performed by the admediary, also referred to as fourth party, and comprises the steps of providing the information received from the first party and receiving a preference request from the user via the second party comprising a session key and a request that applies the session key. In response to the request and in the event that the request matches with the provided information, a response comprising a matching information that applies the session key is provided to the third party.

The method can comprise the step of registering the user with a preference and a time limit. This allows the user to register anonymously for a limited time and to receive advertisements from specific advertiser(s) mating the preferences within the registered time frame.

The request can comprise preferences of the user. This preferences allow to register exactly to the users needs. The preferences of the user can be encrypted by using the session key. This has the advantage that the preferences can only be read by the user itself and the recipient, that is the admediary.

If the information is advertisement provided by the first party with an expiration value, then the admediary always provides up-to-date information for interested customers. This may also reduce storage such as to use it efficiently.

The response with the matching information can be sent directly to the user whenever matching information is identified. This applies to a “push” approach or model described in more detail below. By doing so, the user is always up-to-date and will be delivered with the newest information. However, it is also possible that the response with the matching information is only sent to the user upon another request by said user. This applies to a “pull” approach or model described in more detail below. By doing so, the user has it in its hands when information is received. This allows the user a flexible control of the information that is provided for him or her.

In accordance with another aspect of the present invention, there is provided a system for delivering electronic information anonymously. This arrangement comprise a first party for providing the information, i.e. the advertisement, a third party as user who requests the information with a preference request comprising a session key and a request that applies the session key, a fourth party that in response to the request provides to the third party a response comprising a matching information that applies the session key, and a second party for concealing the traffic between the third party and the fourth party.

Yet another exemplary embodiment of the invention includes a computer program product embodied in a tangible media. The computer readable program codes are coupled to the tangible media for delivering electronic information anonymously, and are configured to cause the program to receive a preference request from a user over a network, match advertising information from at least one advertiser with the preference request, and provide the advertising information to the user in response to the preference request without revealing user information to the advertiser.

The foregoing and other features, utilities and advantages of the invention will be apparent from the following more particular description of various embodiments of the invention as illustrated in the accompanying drawings.

### BRIEF DESCRIPTION OF THE DRAWINGS

Preferred embodiments of the invention are described in detail below, by way of example only, with reference to the following schematic drawings.

FIG. 1 shows an exemplary environment embodying the present invention.

FIG. 2 shows a schematic illustration of an overall scenario to support the understanding of the figures and the description.

FIG. 3 shows a schematic illustration of information flow according to one embodiment of the present invention.

FIG. 4 shows a schematic illustration of a further information flow.

The drawings are provided for illustrative purpose only and do not necessarily represent practical examples of the present invention to scale.

### DETAILED DESCRIPTION OF THE INVENTION

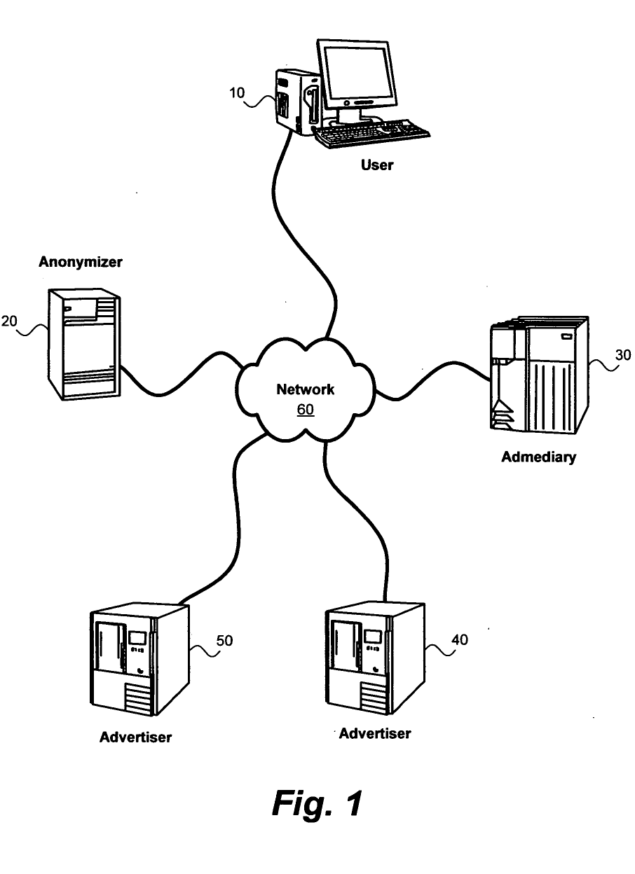

FIG. 1 shows an exemplary environment embodying the present invention. It is initially noted that the environment shown is presented for illustration purposes only, and is representative of countless configurations in which the invention may be implemented. Thus, the present invention should not be construed as limited to the environment configurations shown and discussed herein.

In one configuration of the invention, the environment includes a user 10, an anonymizer 20, an admediary 30, and advertisers 40, 50 coupled to a network 60. The network 60 may be any network known in the art for effecting communications between the entities in the environment. Thus, the network 60 can be a local network (LAN), a wide area network (WAN), or a combination thereof. It is contemplated that the network 60 may be configured as a public network, such as the Internet, and/or a private network, and may include various topologies and protocols known in the art.

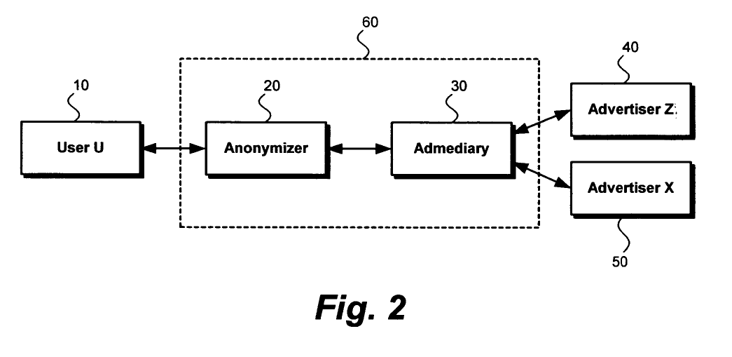

FIG. 2 illustrates how the various environment entities interact with each other. It is understood that the parties are represented by computer, computer devices, or system that are able to communicate or exchange data. Within this description the advertisers 40, 50 are also referred to as first parties or advertisers Z and X. The anonymizer 20 is also referred to as second party. The user 10 is also called third party or user U. Moreover, the admediary 30 is also referred to as fourth party or admediary A. The anonymizer 20 and the admediary 30 together can from a single unit 60.

The user 10 or user U is a person or other entity who wants to receive only the electronic information, in particular advertisement, that the user U is interested in.

The anonymizer 20, also referred to as anonymizing entity, is contemplated as a service that conceals the identity of the user U to the other parties with which the user U interacts through the anonymizer.

The admediary 30 is contemplated as a service that stores the electronic information received from the advertisers 40, 50 in order to deliver the information to the interested users 10. There are many possible realizations of this service. For example, one can distinguish between models where the service is operated by one entity, or by two entities playing the role of anonymizer and admediary. Other distinguishing factors can be the service model assumptions, e.g., “push” models could be considered where the user 10 registers once and receives e-mail advertisements; or “pull” models could be considered where the admediary 30 does not keep any information about the user's registration, but where the user 10 periodically pulls new advertisements based on his or her current registration preferences. For this “pull” model the user 10 will typically use a specialized local application that supports the user 10 in managing his or her preference profile. For pulling advertisement information the user 10 then sends preference information or a preference request and receives as a response the desired information. The “pull” model has the advantage that the user 10 can manage his or her profile locally. Therefore, the user 10 does not need to trust an intermediary party.

A one-entity model, where anonymizer 20 and admediary 30 from a unity as anonymediary 60 requires a large amount of trust in the anonymediary 60. The anonymediary 60 knows the address, e.g. e-mail, or IP, preferences, etc., of the user 10 or customer. For the one-entity model to work it is generally essential that users trust the anonymediary more than they would trust the advertisers 40, 50 they want to receive electronic information from. In order to make this more secure, i.e. against eavesdropping outsiders on the customer-admediary communication channel, the traffic on this channel can be protected by encryption. In the one-entity model, implementing a push model is easy and does not restrict the security or anonymity one could achieve. This is because in the one-entity model, it is assumed that even in the pull model the anonymediary can map an address or, equivalently, the user to preference and registration information.

The two-entity model, as herein described, allows a realization with optimal trust guarantee and separation of knowledge; the anonymizer 20 does not know the user's preferences or registration data, and the admediary 30 does not know any name or addressing information about the user 10.

The advertisers 40, 50 provide electronic information, usually as advertisement, to the admediary 30.

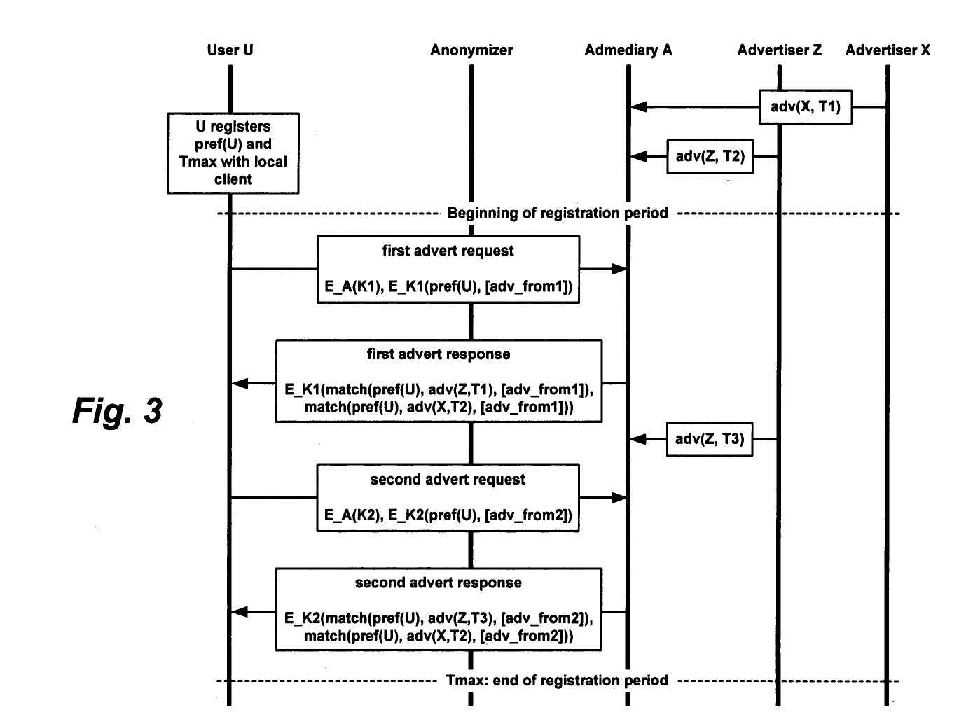

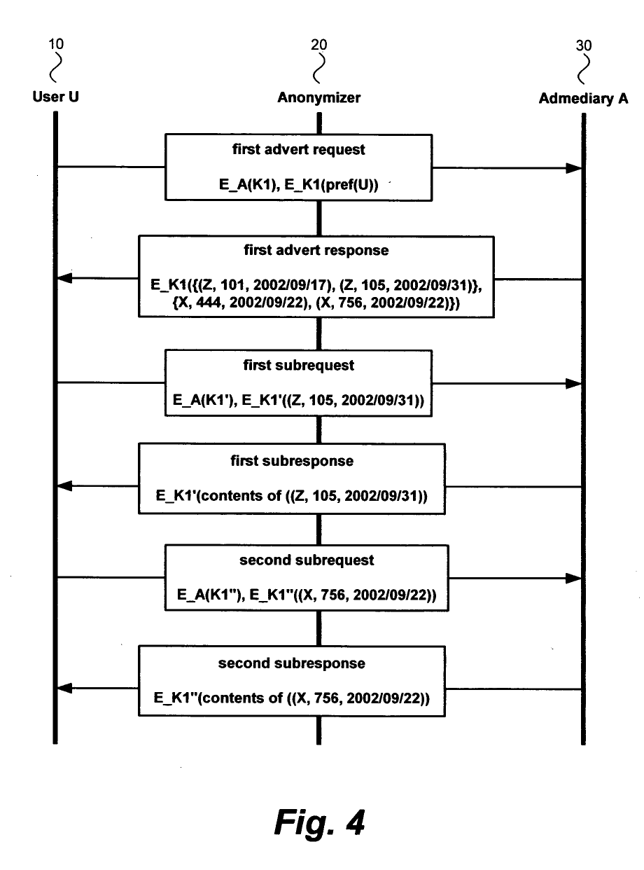

In the following, a most secure embodiment is described in detail with reference to FIG. 3 and FIG. 4.

In general, there are many users U, many advertisers X, Z, . . . , and the admediary A, i.e. the admediary service 30. A user U registers with the system for a limited time period, e.g. until a time Tmax, with a set of preferences pref(U). During that time, until Tmax, the user U will receive advertisements from admediary A that match pref(U). After time Tmax, the user U may re-register with the same or different preferences and a new time Tmax. Advertisers X and/or Z send new advertisements adv(Z, T) at times T to admediary A (periodically, or whenever they have new advertisements). The admediary A has a function or algorithm match(pref, adv) returning a subset of adv which matches pref., that is the user's preferences.

This embodiment realizes this functionality in the two-entity model where users pull information. Generally, the user U does not need to trust any entity or service to respect the chosen time limits for this registration. In order to realize this pull functionality, the existence of a software client at the user's computer is assumed.

The embodiment takes advantage of an anonymizing service 20, hereafter the Anonymizer 20, such as Anonymizer: www.anonymizer.com. The separation of knowledge is achieved as follows:

The Anonymizer 20 acts as a proxy for HTTP requests, and hides the user's address and other information from the Admediary A.

The actual requests/replies for which the Anonymizer 20 acts as a proxy are encrypted with a key shared between the user U and Admediary A, that is the session key K. Thus, the Anonymizer 20 only sees encrypted preferences and advertisements.

In the example scenario, Advertiser Z publishes its current set of advertisements to Admediary A at time Tl, and Advertiser X publishes its current set of advertisements to Admediary A at time T2. Thus, adv(Z, T1) and adv(X,T2) replace any previous adv(Z, Tz) or adv(X,Tx).

Then, the user U registers (pref(U), Tmax) to the system. In this example, registration is local-only: U's local software client will keep track of this registration and will periodically, e.g., once per day until Tmax, pull for new advertisements matching pref(U) by sending an HTTP request to the admediary 30 through the anonymizer 20. In FIG. 3, two such “pulls” are shown: “first advert request” and “second advert request”.

Admediary A has a public/private decryption/encryption key pair (SK_A, PK_A). For each advertisement request, the user U creates a session key, here K1 for the first request, which will be used to encrypt this request/response pair. The user U communicates the session key to the Admediary A by encrypting it with A's public encryption key and sending E_A(K1) together with the encrypted request.

The request comprises pref(U) and optionally a parameter adv_from1 indicating that the user U is only interested in advertisements newer than a certain date. It is assumed that each advertisement is time-stamped by its advertiser such that A's matching function matcho can take adv_from as an additional parameter. Other means to ensure that the user U receives the same advertisement only once are described below.

The response comprises the advertisements matching pref(U), and optionally adv_from, from the different advertisers. After the first advertisement request, Advertizer Z updates its advertisements (adv(Z,T3)). The user's second request, here encrypted with a new session key K₂, will now be matched against adv(Z,T3) and adv(X,T2).

With the presented scheme, a separation of knowledge of address and knowledge of user preferences can be achieved. Because of the encryption with K1 or K2, the Anonymizer 20 cannot find out anything about the user's preferences and the Admediary A cannot find out the user's address.

The trust of the user in anonymity and unlinkability is concentrated in the Anonymizer 20. Also, if the Admediary A is malicious, it can, even without help from Anonymizer 20, try to trace the Anonymizer's incoming/outgoing traffic in order to determine where a request comes from. Both the concentration of trust in the Anonymizer 20 and the traffic tracing can be avoided by replacing the Anonymizer 20 with a mix network, which is described in a paragraph below.

The user U may have several sets of preferences, e.g. each with their own Tmax, in which case the above procedure is executed for each of the user's preference sets. Separating a user's preferences in multiple sets has the additional advantage that the Admediary A cannot link these multiple preference sets to each other. This additional unlinkability provides for more protection against the Admediary's being able to trace slightly varying full preference sets over time and ultimately identifying the user U based on knowledge of his or her full preferences over time.

A local software client can be installed on the user's system which can keep track of a user's registration(s) and deal with the encryption process. This software may but need not be provided by the Admediary A. In either case, it needs to be loaded/initialized with the Admediary's public key PK_A.

If the software is provided by the Admediary A, the Admediary A could also provide a tool that interactively helps the user U to formulate one or several preference sets pref(U).

The adv_from parameter is one of many possible ways of avoiding that the user U gets the same advertisement multiple times. However, it may facilitate additional linking between different requests by the user U, e.g. adv_from, most probably, corresponds to the time of the user's last request with possibly the same preferences. A more secure way would be as follows. It is assumed that each advertisement has an expiration time and a serial number, and that the user client keeps track of a list of tuples (advertiser, serial_nr, expiration). The user client's list is periodically pruned to delete expired entries. When the user U sends an advertisement request, the matching result in the response only contains a similar tuple list of non-expired matching advertisements, e.g., match(pref(U), adv(Z,T3))={(Z, 101, 2002/09/17), (Z, 105, 2002/09/31)}.

At this point, the user client can decide of which serial_nr to really request the contents. This is additional overhead for the user client. But, other than solving the problem of requests using adv_from being linked, it has the additional advantage that the individual ‘sub-requests’ again cannot be linked, especially if the sub-requests are spread over time and each of the sub-requests uses a different session key K1′, K1″, etc. The procedure for the first advertisement request is indicated in FIG. 4. The exchange runs as shown in the figure.

The previous embodiment describes a procedure of achieving anonymous registration. Moreover, one can add the functionality of allowing the Advertiser Z, X to have proof that a customer-transaction is based on an advertisement delivered through the Admediary A. This can be achieved by the Advertiser Z, X encoding in the advertisement a reference, e.g., rA. This could be part of a coupon or another incentive for a customer or user to refer to the advertisement. By giving the customer an incentive to mention rA when making a purchase from the Advertiser Z, X, the Advertiser Z, X can recognize the specific advertisement, e.g., an advertisement made through Admediary A.

A mix network, mentioned above, allows for the realization of anonymous synchronous or asynchronous communication. It is implemented by a number of servers or routers, called mixes, relaying messages or a data stream between parties such that the receiving party cannot trace the origin of traffic or messages. Also, observing third parties (such as parties listening on network links) cannot read messages or data as traffic is encrypted on all the links between mixes, as well as between originator and mix network, as well as between mix network and receiver. More strongly, as mixes buffer and “mix” traffic on different originator-recipient paths, an observing third party cannot even observe which originator is communicating with which recipient. In the most secure implementations, trust requirements on the different mixes are minimized such that, e.g., anonymity requirements are fulfilled as long as one of the mixes is trustworthy.

Mix-based anonymous synchronous communication is the equivalent of a TCP connection between an originator and a receiver, with the feature that the recipient cannot trace the originator; that the communication is encrypted towards any external observer; that none of the relevant mixes sees the content of the communication; and that no external observer (including the recipient) can derive the fact that the originator is communicating with the observer.

Mix-based anonymous asynchronous communication is the equivalent of an originator sending one (or a set of) request e-mail(s) to a recipient, and is able to receive reply e-mail to those e-mails (the number of reply e-mails can be set by the originator), with the feature that the recipient never sees the originator's real e-mail address; that the e-mail content is encrypted on any link of the mix network; that none of the mixes (except the egress mix) sees the content of the e-mail; that none of the mixes (except the ingress mix) ever sees the originator's real e-mail address; and that no external observer (including the recipient) can derive the fact that this originator sends or receives e-mail to/from this recipient. Both types (synchronous or asynchronous) anonymous communication were achieved by the first version of the ZeroKnowledge Freedom network, currently only the synchronous (anonymous version) is offered commercially.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

Any disclosed embodiment may be combined with one or several of the other embodiments shown and/or described. This is also possible for one or more features of the embodiments.

The foregoing description of the invention has been presented for purposes of illustration and description. It is not intended to be exhaustive or to limit the invention to the precise form disclosed, and other modifications and variations may be possible in light of the above teachings. The embodiments disclosed were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for delivering electronic information anonymously from a first party via a second party to a user, the method comprising:
providing the information received from the first party;
receiving a preference request from the user via the second party comprising a session key and a request that applies the session key; and
responsive to the request and in the event that the request matches the provided information, providing to the user a response comprising a matching information that applies the session key.

2. The method according to claim 1, further comprising registering the user with a preference and a time limit.

3. The method according to claim 1, wherein the request comprises preferences of the user.

4. The method according to claim 3, wherein the preferences of the user are encrypted by using the session key.

5. The method according to claim 1, wherein the information is advertisement provided by the first party with an expiration value.

6. The method according to claim 1, wherein providing to the user the response comprises sending the response with the matching information to the user.

7. The method according to claim 1, wherein providing to the user the response comprises sending the response with the matching information to the user upon another request by the user.

8. A computer program element comprising program code means for performing the method according to claim 1 when said program is run on a computer.

9. A computer program stored on a computer usable medium, comprising computer readable program means for causing a computer to perform the method according to claim 1.

10. A system for delivering electronic information anonymously, comprising:
a first party for providing the information;
a user who requests the information with a preference request comprising a session key and a request that applies the session key;
a fourth party that, in response to the request, provides to the third party a response comprising a matching information that applies the session key; and
a second party for concealing the traffic between the user and the fourth party.

11. A computer program product embodied in a tangible media comprising:
computer readable program codes coupled to the tangible media for delivering electronic information anonymously, the computer readable program codes configured to cause the program to:
receive a preference request from a user over a network;
match advertising information from at least one advertiser with the preference request; and
provide the advertising information to the user in response to the preference request without revealing user information to the advertiser.

12. The computer program product according to claim 11, further comprising computer readable program code configured to cause the program to register the user with a preference and a time limit.

13. The computer program product according to claim 11, wherein the preference request comprises preferences of the user.

14. The computer program product according to claim 13, wherein the preferences of the user are encrypted by using the session key.

15. The computer program product according to claim 11, wherein the advertising information includes an expiration value.
